(19) United States
(12) Patent Application Publication
(10) Pub. No.: US 2026/0006148 A1
(43) Pub. Date: Jan. 1, 2026

(54) IMAGE PROCESSING APPARATUS AND ENCRYPTION SETTING METHOD

(71) Applicant: SHARP KABUSHIKI KAISHA, Osaka (JP)

(72) Inventor: MASAHIRO MORISHITA, Osaka (JP)

(21) Appl. No.: 19/241,514

(22) Filed: Jun. 18, 2025

(30) Foreign Application Priority Data
Jun. 26, 2024 (JP) 2024-103192

(51) Int. Cl. H04N 1/44

(52) U.S. Cl. CPC H04N 1/4486; H04N 1/4413; H04N 2201/0094

(57) ABSTRACT

An image processing apparatus includes a transmitter that transmits transmission data to a designated destination, and one or a plurality of controllers that control encryption of the transmission data based on an encryption setting set by a user. The one or the plurality of controllers encrypts the transmission data based on an application setting of either a batch application in which the encryption setting is applied in a batch manner to the transmission data for a plurality of the destinations, or an individual application in which the encryption setting is individually applied to the transmission data for the plurality of destinations, and transmits the encrypted transmission data to the plurality of destinations.

### CROSS REFERENCE TO RELATED APPLICATION

The present application claims priority from Japanese Application JP2024-103192, the content of which is hereby incorporated by reference into this application.

### BACKGROUND OF THE INVENTION

### 1. Field of the Invention

The disclosure relates to an image processing apparatus and an encryption setting method.

### 2. Description of the Related Art

For example, as a technique of the related art, an image processing apparatus is known that can select an encryption level and set an encryption password for image data, when the image data obtained by scanning a document is encrypted and stored in a memory.

### SUMMARY OF THE INVENTION

An object of the disclosure is to provide an image processing apparatus and an encryption setting method capable of improving operability related to an encryption setting such as a selection of an encryption level and a setting of an encryption password for image data.

In order to solve the problems described above, an image processing apparatus according to the disclosure includes a transmitter that transmits transmission data to a designated destination, and one or a plurality of controllers that control encryption of the transmission data based on an encryption setting set by a user. The one or the plurality of controllers encrypt the transmission data based on an application setting of either a batch application in which the encryption setting is applied in a batch manner to the transmission data for a plurality of the destinations, or an individual application in which the encryption setting is individually applied to the transmission data for the plurality of destinations, and the transmitter transmits the transmission data to the plurality of destinations.

Further, an encryption setting method according to the disclosure includes controlling encryption of transmission data based on an encryption setting set by a user, encrypting the transmission data based on an application setting of either a batch application in which the encryption setting is applied in a batch manner to the transmission data for a plurality of the destinations, or an individual application in which the encryption setting is individually applied to the transmission data for the plurality of destinations, and transmitting the encrypted transmission data to the plurality of destinations.

According to the disclosure, it is possible to provide an image processing apparatus and an encryption setting method capable of improving operability related to an encryption setting such as a selection of an encryption level and a setting of an encryption password for image data.

### BRIEF DESCRIPTION OF THE DRAWINGS

FIG. 1 is a diagram illustrating an overall configuration of a multifunction peripheral according to a first embodiment.

FIG. 2 is a diagram illustrating a functional configuration of the multifunction peripheral according to the first embodiment.

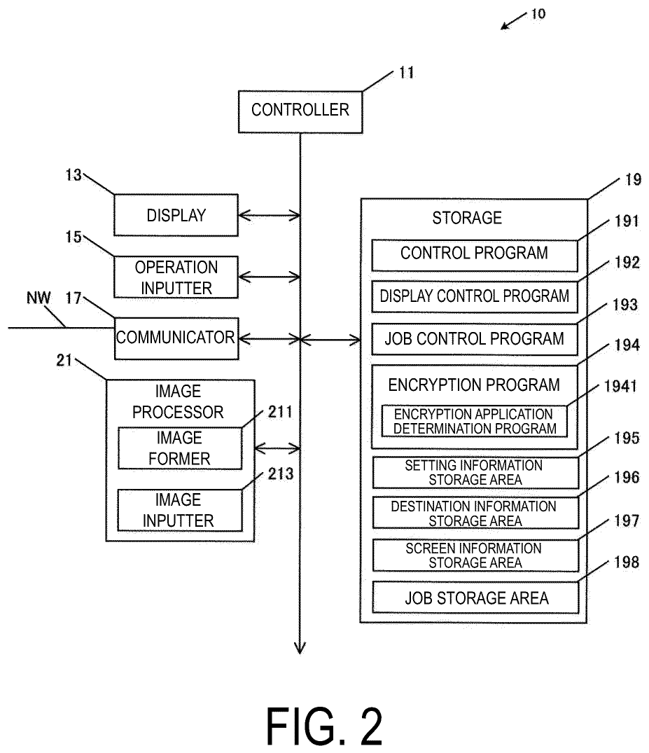

FIG. 3 is a flowchart illustrating a processing flow according to the first embodiment.

FIG. 4 is a flowchart illustrating a processing flow according to the first embodiment.

FIGS. 5A to 5C are diagrams each illustrating an operation example according to the first embodiment.

FIG. 6 is a diagram illustrating an operation example according to the first embodiment.

FIG. 7 is a diagram illustrating an operation example according to the first embodiment.

FIGS. 8A and 8B are diagrams each illustrating an operation example according to the first embodiment.

FIG. 9 is a diagram illustrating an operation example according to the first embodiment.

FIG. 10 is a diagram illustrating an operation example according to the first embodiment.

FIG. 11 is a diagram illustrating an operation example according to the first embodiment.

FIG. 12 is a diagram illustrating an operation example according to the first embodiment.

FIG. 13 is a diagram illustrating an operation example according to the first embodiment.

FIG. 14 is a diagram illustrating an operation example according to the first embodiment.

FIG. 15 is a diagram illustrating an operation example according to the first embodiment.

FIG. 16 is a diagram illustrating an operation example according to the first embodiment.

FIG. 17 is a diagram illustrating an operation example according to the first embodiment.

FIG. 18 is a diagram illustrating an operation example according to the first embodiment.

FIG. 19 is a diagram illustrating an operation example according to the first embodiment.

FIG. 20 is a diagram illustrating an operation example according to the first embodiment.

FIG. 21 is a diagram illustrating an operation example according to the first embodiment.

FIG. 22 is a diagram illustrating an operation example according to the first embodiment.

### DETAILED DESCRIPTION OF THE INVENTION

For example, when PDF (Portable Document Format) image data obtained by scanning a document is encrypted and transmitted to a plurality of destinations, in the related art, a user is not required to input an encryption level and an encryption password for each destination, and the encryption level and the encryption password set by the user are applied to encryption of all of image data (hereinafter may be referred to as transmission data) for the plurality of destinations.

On the other hand, when the user wants to set different encryption levels or different encryption passwords for the respective transmission data for the plurality of destinations, the user needs to execute a transmission job a plurality of times for each of the plurality of destinations, which was troublesome and not user-friendly.

With regard to such an application of the encryption setting such as the selection of the encryption level and the setting of the encryption password for the transmission data, consideration is not given to whether the encryption setting is to be applied to a plurality of destinations in a batch manner or to be individually applied to each destination, nor to whether the user is to be allowed to select one of the application settings.

An image processing apparatus according to the disclosure for solving the above-described problems will be described in the following embodiments with reference to the drawings. Note that the following embodiments describe examples of the disclosure described in the claims, and the technical scope of the disclosure is not limited to the following embodiments.

### 1 First Embodiment

### 1.1 Functional Configuration

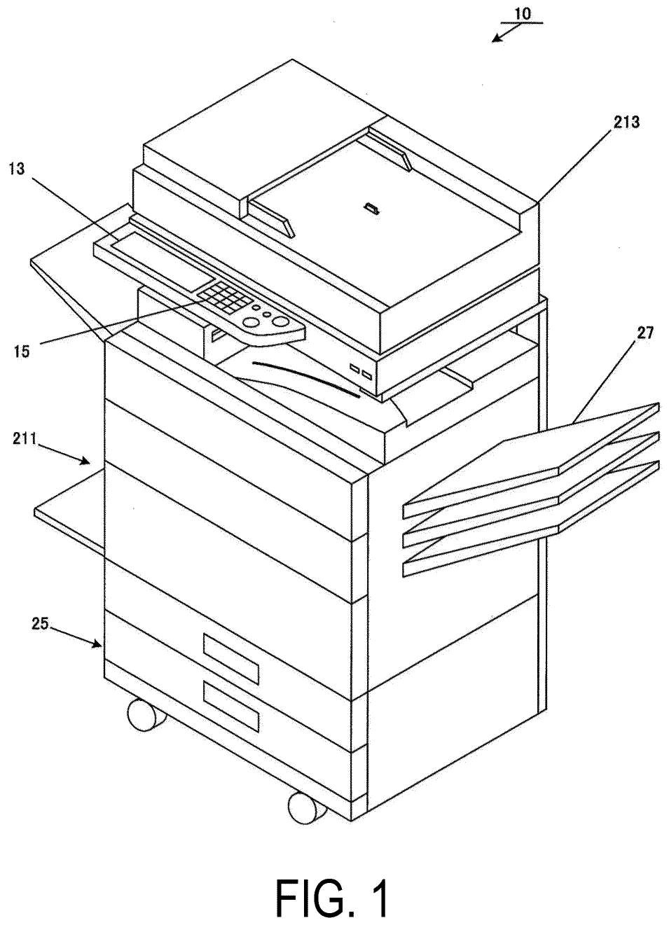

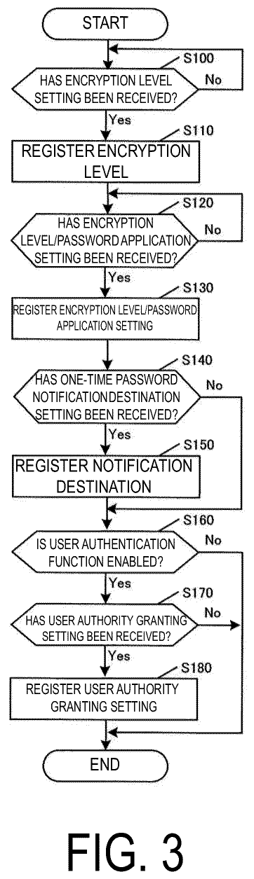

FIG. 1 is a diagram illustrating an overall configuration of a multifunction peripheral 10 as an image processing apparatus. FIG. 3 is a functional configuration diagram of the multifunction peripheral 10.

The multifunction peripheral 10 is an image processing apparatus that can realize a job related to each function, such as a copy function, a fax function, a scan function, and an e-mail function, in a single entity. Note that, in the disclosure, an example of the multifunction peripheral is described as one form of the image processing apparatus. However, the image processing apparatus is not limited to the multifunction peripheral, and may be, for example, an e-mail transmission device, an information processing apparatus (terminal device) compliant with a communication protocol such as Server Message Block (SMB), File Transfer Protocol (FTP), or the like, as long as the image processing apparatus is configured to be able to output image data received as an input, as encrypted transmission data.

The multifunction peripheral 10 described above includes a controller 11, a display 13, an operation inputter 15, a communicator 17, a storage 19, and an image processor 21.

The controller 11 performs overall control of the multifunction peripheral 10. The controller 11 can be constituted by one or a plurality of computation devices (for example, a central processing unit (CPU) or a system on chip (SoC)). The controller 11 realizes the functions of the multifunction peripheral 10 by reading and executing various programs stored in the storage 19.

The display 13 is a display device (display panel) that displays various pieces of information to the user or the like. The display 13 can be constituted by, for example, a liquid crystal display (LCD), an organic electro-luminescence (EL) display, or the like. The display 13 displays, for example, an operation screen such as a home screen (not illustrated) or an encryption setting screen, which will be described below.

The operation inputter 15 is an input device that receives information input by the user or the like. The operation inputter 15 can be constituted by, for example, various input devices such as operation keys including hardware keys and software keys, and buttons. Note that the operation inputter 15 can be constituted as a touch panel that can receive an input via the display 13. When the operation inputter 15 is constituted as the touch panel, the operation inputter 15 can detect a user's touch, tap, or swipe operation, or the like with respect to an object displayed via the display 13, and can acquire coordinate positions, pressure-sensitive information, or the like of touch panel information. In this case, an input scheme for the touch panel can be a general input scheme such as a resistive film scheme, an infrared scheme, an electromagnetic induction scheme, or a capacitive scheme.

The communicator 17 functions as a transmission/reception unit, and is a functional unit that transmits encrypted transmission data or the like to a designated destination, and receives encrypted image data or the like from another device. The communicator 17 described above includes a wired interface, a wireless interface, or wired and wireless interfaces for communication with other devices via a network NW such as a local area network (LAN), a wide area network (WAN), the Internet, a telephone line, or a FAX line. Further, the communicator 17 may also include an interface for short-range wireless communication technology such as Bluetooth (registered trademark), near field communication (NFC), Wi-Fi (registered trademark), ZigBee (registered trademark), infrared data association (IrDA), and wireless universal serial bus (USB).

The storage 19 is one or a plurality of storage devices that store various programs and various pieces of data required for operation of the multifunction peripheral 10. The storage 19 can be constituted by a storage device such as a random access memory (RAM), a solid state drive (SSD), a hard disk drive (HDD), and a read only memory (ROM).

In the first embodiment, the storage 19 stores a control program 191, a display control program 192, a job control program 193, and an encryption program 194, and secures a setting information storage area 195, a destination information storage area 196, a screen information storage area 197, and a job storage area 198.

The control program 191 is a program that the controller 11 reads after the device starts. The controller 11 that has read the control program 191 functions as an operating system (OS) to control driving of hardware such as the display 13, the operation inputter 15, the communicator 17, and the image processor 21.

The display control program 192 is a program that the controller 11 reads when controlling an output of an operation screen displayed on the display 13 or the operation inputter 15 constituted as the touch panel. The controller 11 that has read the display control program 192 displays, on the display 13, a batch application screen or an individual application screen related to the encryption setting, a selection screen related to a user setting in which a selection of either the batch application or the individual application is received, or the like, based on setting content of a system setting set in advance as a device setting, which will be described below.

The job control program 193 is a program that the controller 11 reads when executing a print job related to printing, copying or the like, or a transmission job related to transmission of image data (transmission data) transmitted via e-mail, SMB, FTP, or the like. The controller 11 that has read the job control program 1923 changes a device mode to a job mode for executing each job, and executes various types of jobs. When the controller 11 executes the job, the controller 11 can display, on the display 13, a job setting screen as the operation screen, which receives a selection of a setting value or a function required for execution of the job from the user, as necessary. The controller 11 can execute the job based on the setting value or the function received via the job setting screen.

The encryption program 194 is a program that is read by the controller 11 when encrypting image data such as the transmission data. The controller 11 that has read the encryption program 194 encrypts the transmission data or the like at an encryption level such as RC4 128 bit, AES 128 bit, or AES 256 bit using an encryption password input by the user. Note that, in the disclosure, the setting related to encryption including the encryption level to be applied to the transmission data to be encrypted and the encryption password to be used for encryption (or decryption) is referred to as an encryption setting, but the encryption setting may include setting values and information related to encryption other than the encryption level and the encryption password. Further, the controller 11 that has read the encryption program 194 receives an input of a selection value or a setting value related to the encryption setting from the user, and registers the input in the setting information storage area 195 as the encryption setting.

The encryption program 194 described above includes an encryption application determination program 1941. The controller 11 that has read the encryption application determination program 1941 determines whether the user has selected, as an encryption application setting, either the batch application in which the encryption setting is applied to transmission data for a plurality of destinations in a batch manner, or the individual application in which the encryption setting is individually applied to transmission data for individual destinations included in the plurality of destinations. Then, the controller 11 encrypts the transmission data to which the encryption is to be applied, in accordance with the selected application setting.

The setting information storage area 195 is a storage area that stores information related to the encryption setting such as the selection value of the encryption level and the encryption password, setting values/selection information input by the user via the job setting screen, and various pieces of setting information necessary for operation of the multifunction peripheral 10.

The destination information storage area 196 is a storage area that stores destination information including transmission destinations of the transmission data. The destination information may be, for example, an e-mail address specifying the transmission destination of e-mail, a file path specifying the storage destination of a file by SMB or FTP, or an address specified by the user such as an IP address, but is not particularly limited as long as it is information that can specify the transmission destination of the transmission data, and may be identification information unique to a device such as a media access control address (MAC address).

The screen information storage area 197 is a storage area that stores display content necessary for displaying operation screens such as the job setting screen and the setting screen or the selection screen related to the encryption setting.

The job storage area 198 is a storage area that stores various jobs such as a transmission job and a print job related to printing, copying, or the like. Note that the job storage area 198 can also store a deliverable generated by executing a job. For example, when the executed job is a scan job, the controller 11 stores image data generated by the image processor 21 (image inputter 213) in the job storage area 198. When the job type of the executed job is, for example, scan to e-mail, the controller 11 may prepare the image data for transmission and store the prepared image data as transmission data in the job storage area 198, or may store encrypted transmission data in the job storage area 198.

The image processor 21 includes an image former 211 and an image inputter 213. The image former 211 receives a sheet as a sheet-like medium fed from a sheet feeder 25, forms an image on the sheet based on image data, and then discharges the sheet to a sheet discharger 27. The image former 211 can be constituted by, for example, an electrophotographic laser printer.

The image inputter 213 generates image data by scanning a document. The image inputter 213 can be constituted as a scanner device including an automatic document feeder (ADF), a flatbed for placing and reading a document, and the like in addition to an image sensor such as a charge coupled device (CCD) or a contact image sensor (CIS). There is no particular limitation on the configuration of the image inputter 213 as long as the image inputter 213 can generate image information by causing the image sensor to read a light image reflected from a document image. Note that the image inputter 213 can also be constituted as an interface that can acquire image information stored in a storage medium such as a USB memory, or image data transmitted from a device (not illustrated) such as an information processing apparatus. Note that the image processor 21 may perform, for example, shading correction or density correction on the image data input from the image inputter 213 to generate the transmission data.

### 1.2 Processing Flow

Next, a processing flow according to the first embodiment will be described. FIG. 3 is a flowchart illustrating processing related to registration of the encryption setting. The processing described in FIG. 3 is executed by the controller 11 reading the control program 191, the display control program 192, the encryption program 194, and the like. Note that the encryption setting illustrated in FIG. 3 can be performed as one of setting items included in the system setting (device setting).

When the processing is started, the controller 11 determines whether the setting of the encryption level has been received from the user (step S100). When it is determined that the setting of the encryption level has been received, the controller 11 registers the received encryption level in the storage 19 (step S100; Yes→step S110). Note that when the controller 11 determines that the setting of the encryption level has not been received, the controller 11 waits until the setting of the encryption level is received (step S110; No).

Subsequently, the controller 11 determines whether the application setting of the encryption level/password has been received (step S120). In the application setting of the encryption level/password, the controller 11 receives a selection of the application setting related to the encryption setting from one of the batch application, the individual application, and the user setting in which the selection of either the batch application or the individual application is received as the application setting. When it is determined that the application setting of the encryption level/password has been received, the controller 11 registers the received application setting of the encryption level/password in the storage 19 (step S120; Yes→step S130). At this time, when individually applying the encryption setting, which will be described later, the user may perform, with respect to the transmission data to be transmitted to a plurality of destinations, processing of registering applicable destinations to which the encryption setting is to be applied in the batch manner. When it is determined that the application setting of the encryption level/password has not been received, the controller 11 returns the processing to step S120.

At step S140, the controller 11 determines whether a notification destination setting of a one-time password has been received. Note that generation of the one-time password is not essential and is more effective when the individual application of the encryption setting is selected than when the batch application is selected, in terms of simplifying the setting of the password for each destination. The processing related to step S140 is not essential and may only be executed when the individual application is selected at step S120. In the notification destination setting of the one-time password, the controller 11 receives, after transmission of the transmission data, the notification destination setting of the one-time password that is used for decrypting encrypted transmission data. When it is determined that the notification destination setting of the one-time password has been received, the controller 11 registers the received notification destination setting of the one-time password in the storage 19 (step S140; Yes→step S150). When it is determined that the notification destination setting of the one-time password has not been received, the controller 11 omits the processing related to step S150 and causes the processing to proceed to step S160 (step S140; No→step S160).

Then, the controller 11 determines whether a user authentication function is enabled (step S160). When it is determined that the user authentication function is enabled (Step S160; Yes), the controller 11 determines whether an authority granting setting related to the encryption setting has been performed for each user to be authenticated (step S170). When it is determined that the authority granting setting related to the encryption setting has been performed for each user, the controller 11 registers the setting and ends the processing (step S170; Yes→step S180). Note that when it is determined that the user authentication function is disabled (step S160; No) or when the authority granting setting related to the encryption setting has not been performed for each user (step S170; No), the controller 11 ends the processing.

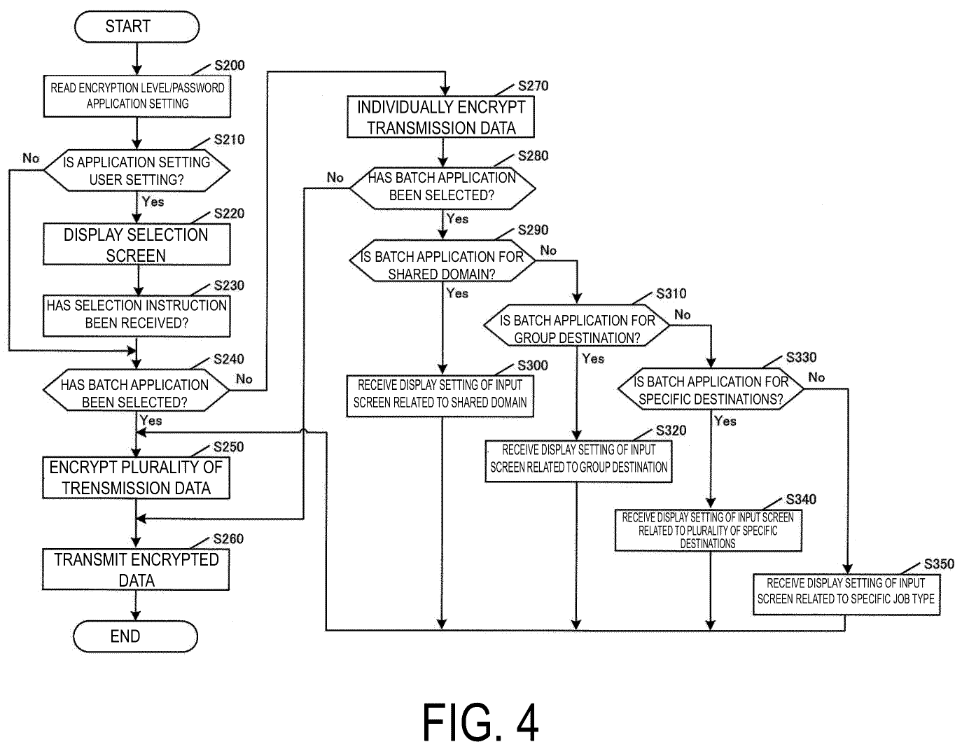

Next, processing from application of the encryption setting to transmission of encrypted transmission data at the time of executing a transmission job will be described with reference to the flowchart in FIG. 4. The processing described in FIG. 4 is executed by the controller 11 reading the control program 191, the display control program 192, the job control program 193, the encryption program 194 (encryption application determination program 1941), and the like.

When the processing is started, the controller 11 reads the encryption level/password application setting registered at step S130 in FIG. 3 (step S200). The controller 11 determines whether the application setting is the user setting, based on the read encryption level/password application setting (step S210).

When it is determined that the user setting is registered as the encryption level/password application setting, the controller 11 displays, on the display 13, the selection screen for receiving a selection of the batch application or the individual application (step S210; Yes→step S220). Subsequently, the controller 11 receives a user's selection of the batch application or the individual application (step S230). Note that when it is determined that the user setting is not registered as the encryption level/password application setting, the controller 11 causes the processing to proceed to step S240 (step S210; No→step S240).

Then, the controller 11 determines whether the batch application has been selected by the user via the selection screen or in the encryption level/password application setting read at step S200 (step S240).

When it is determined that the batch application has been selected, the controller 11 encrypts transmission data corresponding to a plurality of destinations in a batch manner (while applying the same encryption setting) (step S240; Yes→step S250). Then, the controller 11 transmits the transmission data that have been encrypted by applying the same encryption setting, to all of destinations included in the plurality of destinations, and ends the processing (step S260).

At step S240, when it is determined that the batch application has not been selected, the controller 11 performs individual encryption processing of the transmission data (step S240; No→step S270).

At this time, the controller 11 determines whether the batch application has been selected for at least some of the plurality of destinations (step S280). When it is determined that the batch application has not been selected for at least some of the plurality of destinations, the controller 11 applies individual encryption settings to each of the transmission data, transmits the encrypted transmission data to each of the plurality of destinations, and ends the processing (step S280; No→step S260).

On the other hand, when it is determined that the batch application has been selected for at least some of the plurality of destinations, the controller 11 determines whether or not the batch application is applied to a plurality of destinations having a shared domain (step S280; Yes→step S290). When it is determined that the batch application is applied to the plurality of destinations having the shared domain, the controller 11 displays an input screen for applying the batch application to the shared domain, and receives a necessary setting via the input screen (step S290; Yes→step S300). Then, the controller 11 encrypts in a batch manner transmission data for the plurality of destinations having the shared domain while applying the same encryption setting to the transmission data, transmits the encrypted transmission data to the plurality of destinations having the shared domain, and ends the processing (step S250→step S260).

On the other hand, when it is determined that the batch application is not applied to the plurality of destinations having the shared domain, the controller 11 determines whether the batch application is applied to a group destination in which a plurality of destinations are collected as one destination (step S290; No→step S310). When it is determined that the batch application is applied to the group destination, the controller 11 displays an input screen for applying the batch application to the group destination and receives a necessary setting via the input screen (step S310; Yes→step S320). Then, the controller 11 encrypts in a batch manner transmission data for the plurality of destinations related to the group destination while applying the same encryption setting to the transmission data, transmits the encrypted transmission data to the plurality of destinations included in the group destination, and ends the processing (step S250→step S260).

On the other hand, when it is determined that the batch application is not applied to the group destination, the controller 11 determines whether the batch application is applied to a plurality of specific destinations (step S310; No→step S330). When it is determined that the batch application is applied to the plurality of specific destinations, the controller 11 displays an input screen for applying the batch application to the plurality of specific destinations, and receives a necessary setting via the input screen (step S330; Yes→step S340). Then, the controller 11 encrypts in a batch manner transmission data for a plurality of destinations related to the plurality of specific destinations while applying the same encryption setting to the transmission data, transmits the encrypted transmission data to the plurality of destinations included in the plurality of specific destinations, and ends the processing (step S250→step S260).

When it is determined that the batch application is not applied to the plurality of specific destinations, the controller 11 determines that the batch application is applied to destinations related to a specific job type. Then, the controller 11 displays an input screen for applying the batch application to the destinations related to the specific job type, and receives a necessary setting via the input screen (step S330; No→step S350). Then, the controller 11 encrypts in a batch manner transmission data for a plurality of destinations related to the destinations of the specific job type while applying the same encryption setting to the transmission data, transmits the encrypted transmission data to the plurality of destinations included in the destinations of the specific job type, and ends the processing (step S250→step S260).

In FIG. 4, the processing related to step S290 to step S350 has been described as a series of continuous processes, but these continuous processes may be one independent process, and for example, control may be performed such that the applicable destinations to which the same encryption setting is to be applied in the batch manner are limited to the destinations having the shared domain.

### 1.3 Operation Examples

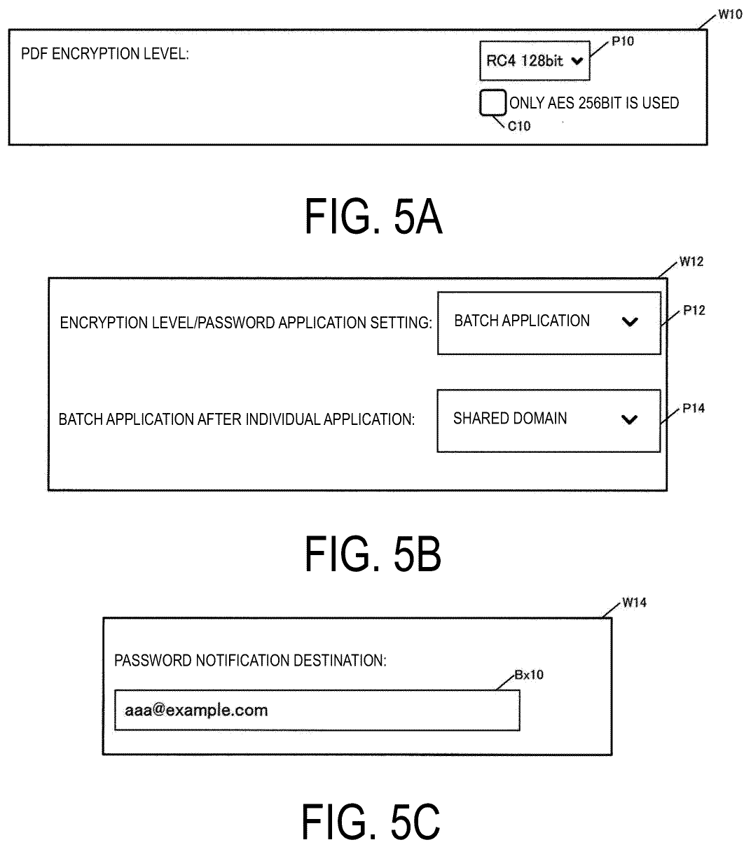

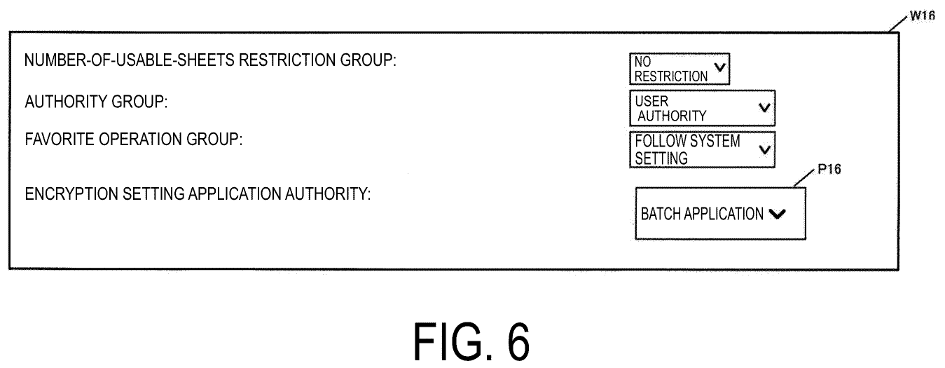

Next, operation examples according to the first embodiment will be described. FIGS. 5A and 5B is a diagram illustrating a configuration example of encryption setting screens W10 to W14 for receiving the encryption setting from the user. Note that it is assumed that encryption setting performed using the encryption setting screens W10 to W14 illustrated in FIGS. 5A and 5B, and a setting related to an operation authority granted to the user to be authenticated illustrated in FIG. 6 are performed as one of the setting items included in the system setting (device setting).

The encryption setting screen W10 illustrated in FIG. 5A is a configuration example of an encryption setting screen for receiving a selection of the encryption level by the user, and is an operation example corresponding to the processing related to step S100 in FIG. 3.

The encryption setting screen W10 includes an encryption level selection pull-down menu P10 and an applied encryption level check box C10. The encryption level selection pull-down menu P10 is a pull-down menu for receiving a selection of the encryption level that the user desires to apply. Although not illustrated in FIG. 5A, in the encryption level selection pull-down menu P10, the user can select one of the encryption levels, for example, RC4 128 bit, AES 128 bit, and AES 256 bit.

The applied encryption level check box C10 is a check box for receiving a selection by the user when the user wants to limit the encryption level to be applied. FIG. 5A illustrates an example in which the encryption level to be applied can be limited to the AES 256 bit. When the check box is checked by the user, the controller 11 performs encryption by limiting (fixing) the encryption level to the AES 256 bit. Therefore, as illustrated in an input screen W33, which will be described below, the user cannot select the encryption level on the job setting screen.

The encryption setting screen W12 illustrated in FIG. 5B is a configuration example of an encryption setting screen for receiving a selection of the encryption level/password application setting by the user, and is an operation example corresponding to the processing related to step S120 in FIG. 3.

The encryption setting screen W12 includes an application setting selection pull-down menu P12 and an applicable destination selection pull-down menu P14. The application setting selection pull-down menu P12 is a pull-down menu for receiving a selection of the application setting that the user desires to apply. In the application setting selection pull-down menu P12, the user can select one of the batch application, the individual application, and the user setting in which a selection of either the batch application or the individual application is received as the application setting, and in FIG. 5B, a state in which the batch application is selected as the application setting by the user is illustrated. Further, when individually applying the encryption setting, the applicable destination selection pull-down menu P14 is a pull-down menu for receiving a selection of the applicable destinations when applying the encryption setting in the batch manner to the transmission data for at least some of the plurality of destinations. In the applicable destination selection pull-down menu P14, it is possible to receive a selection of one or a plurality of destinations from destinations having a shared domain, a group destination in which a plurality of destinations are collected as one destination, a plurality of specific destinations, and destinations related to a specific job type. In FIG. 5B, a state is illustrated in which the shared domain (destinations having the shared domain) is selected by the user as the applicable destinations to which the encryption setting is to be applied in the batch manner. Note that the applicable destination selection pull-down menu P14 may be disabled (grayed out) so that the user cannot make the selection until the individual application is selected in the application setting selection pull-down menu P12.

The encryption setting screen W14 illustrated in FIG. 5C is a configuration example of an encryption setting screen for receiving an input of the notification destination of the one-time password by the user, and is an operation example corresponding to the processing related to step S140 in FIG. 3. Note that the generation of the one-time password is not essential, but is effective when the individual application is selected in the application setting selection pull-down menu P12 in terms of being able to simplify the setting of the password for each destination.

The encryption setting screen W14 is a screen for setting the notification destination of the one-time password generated based on an instruction from the user, and includes a password notification destination input box Bx10. The password notification destination input box Bx10 is an input box for receiving an input of the notification destination of the one-time password desired by the user, and in FIG. 5C, a state is illustrated in which “aaa@example.com” is input by the user as the notification destination.

FIG. 6 is a configuration example of a user setting screen W16 for receiving a setting related to the operation authority granted to the user to be authenticated, and is an operation example corresponding to step S170 in FIG. 3.

The user setting screen W16 includes an application authority of the encryption setting, in addition to items related to the operation authority granted to the user to be authenticated by an administrator (user) of the multifunction peripheral 10 such as a number-of-usable-sheets restriction group, an authority group, and a favorite operation group. Similarly to the encryption setting screen W12 illustrated in FIG. 5B, the application authority of the encryption setting includes an application setting selection pull-down menu P16.

Similarly to the application setting selection pull-down menu P12, in the application setting selection pull-down menu P16, the user can select one of the batch application, the individual application, and the user setting as the application setting. Note that, for example, for the user to whom the batch application is granted via the application setting selection pull-down menu P16, even if the user setting is selected as the application setting in the application setting selection pull-down menu P12, the batch application selected via the application setting selection pull-down menu P16 is prioritized. That is, when an operation mode is adopted in which a user authentication is required when the user uses the multifunction peripheral 10, the application authority of the encryption setting granted to the user (for example, batch application) is applied regardless of the application setting as the device (for example, user setting).

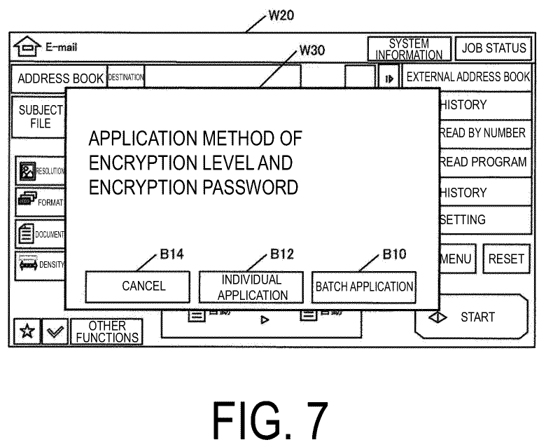

Next, FIG. 7 is a diagram illustrating a configuration example of a selection screen W30 displayed by the controller 11 so as to be superimposed on the job setting screen W20 related to e-mail. The selection screen W30 is an operation example corresponding to step S210 (Yes) and step S220 in FIG. 44 and is a selection screen displayed when the encryption level/password application setting is set to the user setting. The selection screen W30 is not displayed when the encryption level/password application setting is set to the batch application or the individual application. The selection screen W30 is displayed, for example, when a set button related to encryption of the transmission data is selected on the job setting screen W20 related to e-mail, or when a start button for instructing start of execution of a job is selected in a state in which a setting for encrypting the transmission data is enabled and a plurality of destinations are selected as transmission destinations of the transmission data.

The selection screen W30 includes a batch application button B10, an individual application button B12, and a cancel button B14.

The batch application button B10 is a button for receiving a user's instruction to select the batch application as the application setting. The individual application B12 is a button for receiving a user's instruction to select the individual application as the application setting. The cancel button B14 is a button for receiving a user's instruction to cancel the application setting.

When the controller 11 receives the user's instruction to select one of the batch application buttons B10 and the individual application button B12 via the selection screen W30, the controller 11 executes the processing at step S230 and the subsequent steps in FIG. 4. Further, when the controller 11 receives the user's instruction to select the cancel button B14 via the selection screen W30, the controller 11 ends the display of the selection screen W30 and displays the previous screen. For example, when the selection screen W30 is displayed by selecting the start button for instructing the start of execution of the job, the controller 11 displays, as the previous screen, the job setting screen W20 in a state in which the transmission data is set to be encrypted and a plurality of destinations are selected as the transmission destinations of the transmission data.

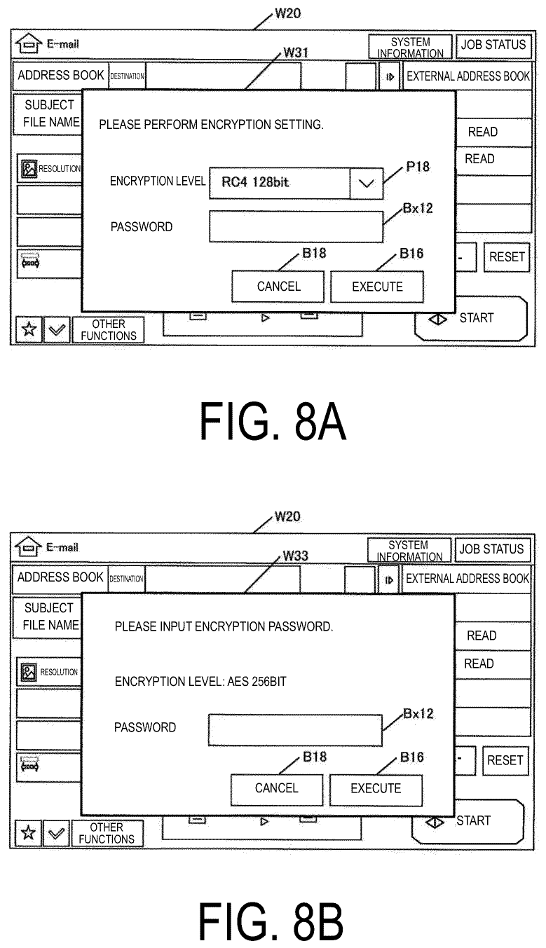

FIG. 8A illustrates a configuration example of an input screen W31 displayed by the controller 11 when the batch application button B10 is selected by the user on the selection screen W30 illustrated in FIG. 7. Note that FIGS. 8A and 8B are operation examples corresponding to the processing at step S240 in FIG. 4. The input screen W31 includes a notification “Please input a password for encrypted PDF.” prompting the user to input an encryption password to be applied in the batch manner to PDF (transmission data) for a plurality of destinations, an encryption level selection pull-down menu P18, a password input box Bx12, an execution button B16, and a cancel button B18. Note that the input screen W31 is also displayed when the batch application is selected as the application setting in the application setting selection pull-down menu W12 of the encryption setting screen P12 illustrated in FIG. 5B, that is, when the batch application is selected in the system setting (device setting).

The encryption level selection pull-down menu P18 is a pull-down menu for receiving a selection of the encryption level that the user desires to apply. Although not illustrated in FIG. 8A, in the encryption level selection pull-down menu P10, one of the encryption levels RC4 128 bit, AES 128 bit, and AES 256 bit can be selected.

The password input box Bx12 is an input box for receiving an input of the encryption password to be used when encrypting the PDF in accordance with the encryption level selected via the encryption level selection pull-down menu P18. The input condition of the encryption password may be changed in accordance with the encryption level selected via the encryption level selection pull-down menu P18.

The execution button B16 is a button for receiving an instruction to execute the application, in the batch manner, of the encryption level selected via the encryption level selection pull-down menu P18 and the encryption password input via the password input box Bx12 as the encryption setting, to the transmission data (PDF) for the plurality of destinations. When the controller 11 receives an instruction to select the execution button B16, the controller 11 executes the encryption of the transmission data. The controller 11 may also execute transmission of the encrypted transmission data to the plurality of destinations.

The cancel button B18 is a button for receiving an instruction to cancel the selection instruction via the encryption level selection pull-down menu P18, and the input instruction via the password input box Bx12. When an instruction to select the cancel button B18 is received, controller 11 ends the reception operation via the input screen W31, ends the display of the input screen W31, and returns the display to the previous screen (in this case, the selection screen W30). Note that, as illustrated in FIGS. 8A and 8B, with respect to the cancel button B18 displayed together with the (job) execution button, when a user's instruction to select the cancel button B18 is received, it is also possible to cancel the job itself and, for example, display an initial screen of the setting screen W20 related to e-mail.

FIG. 8B illustrates a configuration example of another input screen W33 displayed by the controller 11 when the batch application B10 is selected by the user on the selection screen W30 illustrated in FIG. 7. The input screen W33 illustrated in FIG. 8B is an input screen displayed by controller 11 when the applied encryption level check box C10 is checked on the encryption setting screen W10 illustrated in FIG. 5A and the encryption level to be applied for encryption is selected in advance.

In the input screen W33 illustrated in FIG. 8B, since the encryption level to be applied is selected (limited) in advance, the encryption level selection pull-down menu P18 for receiving the selection of the encryption level is not displayed, and the encryption level set (fixed) as the encryption level to be applied is displayed (for example, AES 256 bit). Since the configuration of the password input box Bx12, the execution button B16, and the cancel button B18 can be the same as the configuration illustrated in FIG. 8A, description thereof is omitted here.

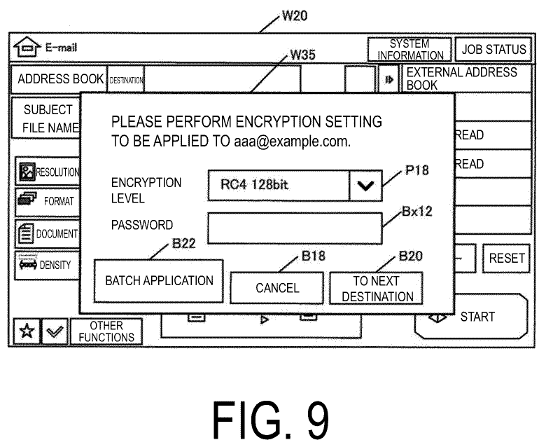

FIG. 9 illustrates a configuration example of an input screen W35 displayed by the controller 11 when the individual application button B12 is selected by the user on the selection screen W30 illustrated in FIG. 7. The input screen W35 includes a notification “Please perform encryption setting to be applied to aaa@example.com.” prompting the user to input the encryption password for individually encrypting the PDF (transmission data) for one destination (for example, aaa@example.com) included in the plurality of destinations selected as the destinations of the transmission data, the encryption level selection pull-down menu P18, the password input box Bx12, a next destination button B20, the cancel button B18, and a batch application button B22. Since the configuration of the encryption level selection pull-down menu P18, the password input box Bx12, and the cancel button B18 can be the same as the configuration illustrated in FIG. 8A or FIG. 8B, description thereof is omitted here.

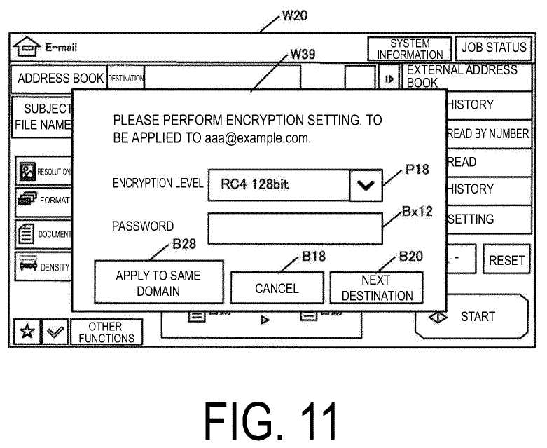

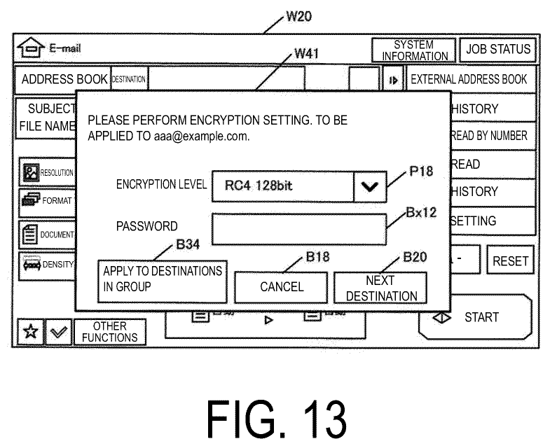

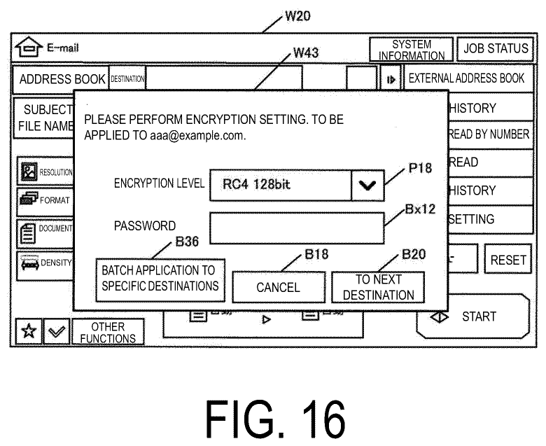

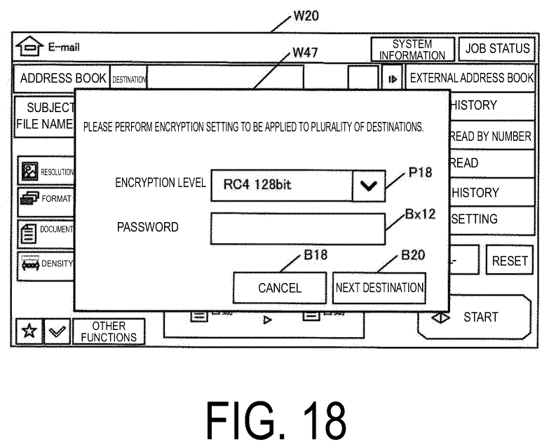

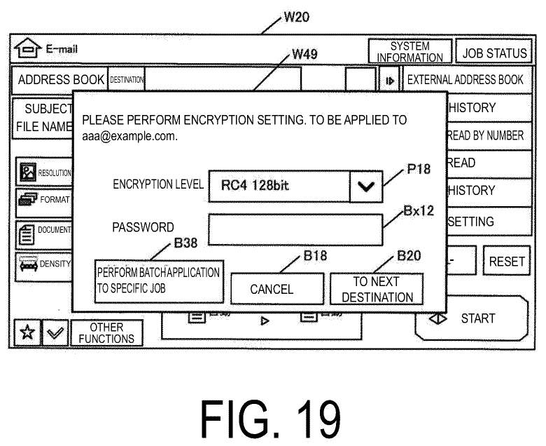

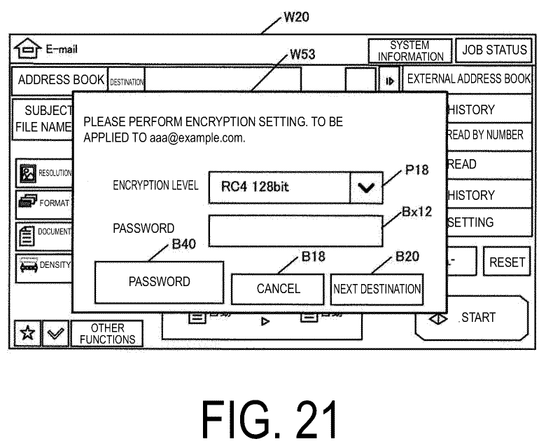

The next destination button B20 is a button for receiving an instruction to display an input screen for performing the encryption setting for the next destination included in the plurality of destinations selected as the destinations of the transmission data. When a user's instruction to select the next destination button B20 is received, the controller 11 displays an input screen in which “aaa@example.com” included in the notification on the input screen W35 is replaced with a next destination (for example, bbb@example.jp) for which the encryption setting is not set, receives the encryption setting for the transmission data to be transmitted to the next destination via the displayed input screen, and applies the received encryption setting to the transmission data to be transmitted to the next destination. Note that when the next destination button B20 is selected by the user and the reception of the input of the encryption setting for all the destinations designated as the transmission destinations of the transmission data is completed, the controller 11 displays the execution button B16 instead of the next destination button B20 and the batch application button B22, and can receive an instruction to execute the job. Note that the input screen displayed by the controller 11 in response to the instruction to select the next destination button B20 is the same in the cases of an input screen W39 illustrated in FIG. 11, an input screen W41 illustrated in FIG. 13, an input screen W43 illustrated in FIG. 16, an input screen W47 illustrated in FIG. 18, an input screen W49 illustrated in FIG. 19, and an input screen W53 illustrated in FIG. 21.

When there are a plurality of other transmission data to which the encryption setting is individually applied, the batch application B22 is a button for receiving an instruction to select the batch application to perform the encryption setting on those other transmission data in the batch manner. When a user's instruction to select the batch application button B22 is received, the controller 11 displays an input screen for applying the batch application to the applicable destinations received via the applicable destination selection pull-down menu P14 on the encryption setting screen W12.

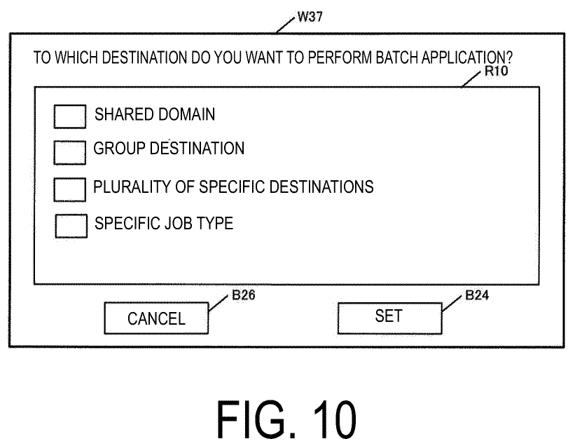

Note that when the applicable destinations to which the encryption setting is to be applied in the batch manner have not been selected via the applicable destination selection pull-down menu P14 on the encryption setting screen W12, for example, the applicable destinations to which the encryption setting is to be applied in the batch manner may be received via an applicable destination selection screen W37 illustrated in FIG. 10.

The applicable destination selection screen W37 illustrated in FIG. 10 includes a selection area R10 for receiving a selection of one or a plurality of destinations, as the destination to which the encryption setting is to be applied in the batch manner, from the destinations having the shared domain (shared domain), the group destination in which the plurality of destinations are collected as one destination (group destination), the plurality of specific destinations selected by the user (plurality of specific destinations), and the destinations related to the specific job type (specific job type). The applicable destination selection screen W37 also includes a set button B24, and a cancel button B26. After selecting desired applicable destinations via the selection area R10, the user selects the set button B24 to encrypt the transmission data for the selected applicable destination in the batch manner. The cancel button B26 is a button for receiving an instruction to cancel the selection of the destination via the applicable destination selection screen W37. Upon receiving an instruction to select the cancel button B26, controller 11 ends the display of the applicable destination selection screen W37 and displays the previous screen (in this case, the input screen W35).

The batch application button B22 included in the input screen W35 illustrated in FIG. 9 and the applicable destination selection screen W37 displayed in response to an instruction to select the batch application button B22 may be omitted when the applicable destinations to which the batch application is to be applied is set in advance in the system setting (device setting).

FIG. 11 is a configuration example of the input screen W39 displayed by the controller 11 when the destinations having the shared domain (shared domain) is selected as the applicable destinations to which the encryption setting is to be applied in the batch manner, and is an operation example corresponding to the processing at step S300 in FIG. 4. The input screen W39 includes an apply-to-same-domain button B28 instead of the batch application button B22 of the input screen W35 illustrated in FIG. 9. Since the configuration other than the apply-to-same-domain button B28 can be the same as that of the input screen W35, description thereof is omitted here.

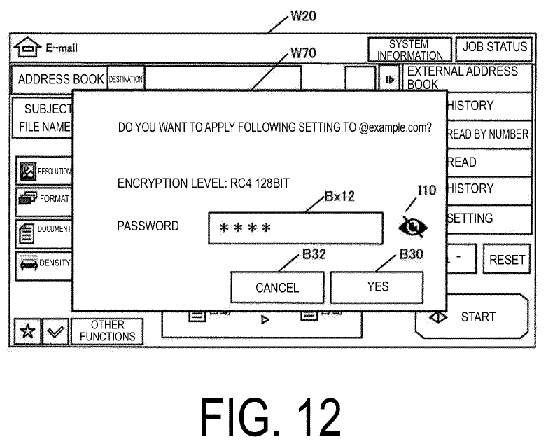

The apply-to-same-domain button B28 is a button for receiving an instruction to select destinations having the same (shared) domain (@example.com) as “aaa@example.com”, as the destinations to which the encryption setting is to be applied in the batch manner. Upon receiving an instruction to select the apply-to-same-domain button B28, the controller 11 displays an application confirmation screen W70, which will be described below with reference to FIG. 12.

FIG. 12 is a diagram illustrating a configuration example of the application confirmation screen W70. The application confirmation screen W70 includes a notification “Do you want to apply the following setting to @example.com?” indicating that the encryption setting is applied in the batch manner to the destinations having the same domain (@example.com) other than “aaa@example.com”, the encryption level “RC4 128 bit” selected on the input screen W39, the password input box Bx12, a password display restriction icon 110, a YES button B30, and a cancel button B32.

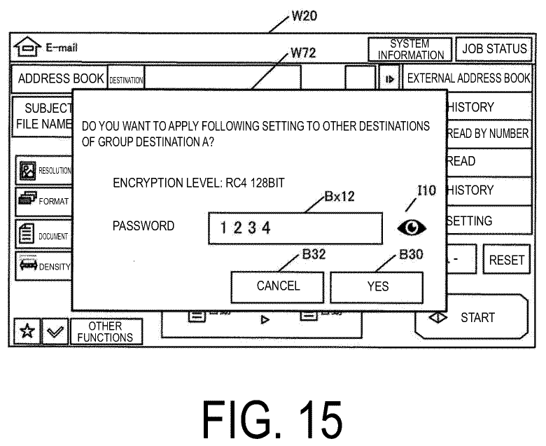

In the password input box Bx12, the encryption password input on the input screen W39 is displayed using privacy protection characters of “****”. The password display restriction icon 110 is an icon for receiving an instruction to display the encryption password input to the password input box Bx12. FIG. 12 illustrates a state in which the encryption password input into the password input box Bx12 is hidden by the privacy protection characters (a state in which a diagonal line is added to an eye portion of the icon). When the password display restriction icon 110 is selected by the user, the display state of the icon changes, and the encryption password input to the password input box Bx12 can be made visible (a state in which the diagonal line is removed from the eye portion of the icon, for example, as illustrated in FIG. 15).

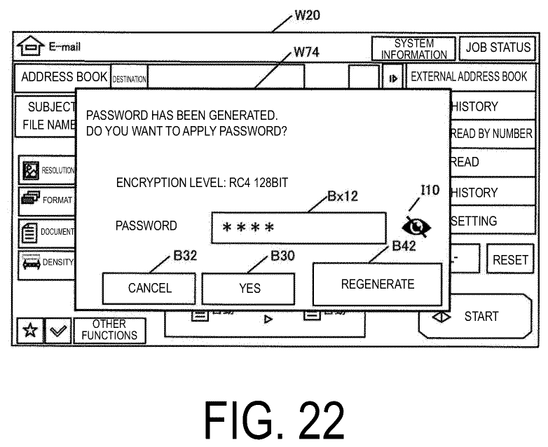

The YES button B30 is a button for receiving an input instruction to apply the encryption setting displayed on the application confirmation screen W70. Note that when the reception of the input of the encryption setting for all the destinations designated as the transmission destinations of the transmission data is completed, the controller 11 displays the execution button B16 instead of the YES button B30 and can receive instructions to execute the job. Note that the same applies to the YES button B30 included in an application confirmation screen W72 illustrated in FIG. 15, and the YES button B30 included in a password generation screen W74 illustrated in FIG. 22. The cancel button B32 is a button for receiving an instruction to cancel the application of the encryption setting displayed on the application confirmation screen W70. Upon receiving an instruction to select the cancel button B32, the controller 11 ends the display of the application confirmation screen W70 and displays the previous screen (in this case, the input screen W39).

FIG. 13 is a configuration example of an input screen W41 displayed by the controller 11 when the group destination in which the plurality of destinations are collected as one destination (group destination) is selected as the destination to which the encryption setting is to be applied in the batch manner, and is an operation example corresponding to the processing at step S320 in FIG. 4. The input screen W41 includes an apply-to-destinations-in-group button B34 instead of the batch application button B22 of the input screen W35 illustrated in FIG. 9. Since the configuration other than the apply-to-destinations-in-group button B34 can be the same as that of the input screen W35, description thereof is omitted here.

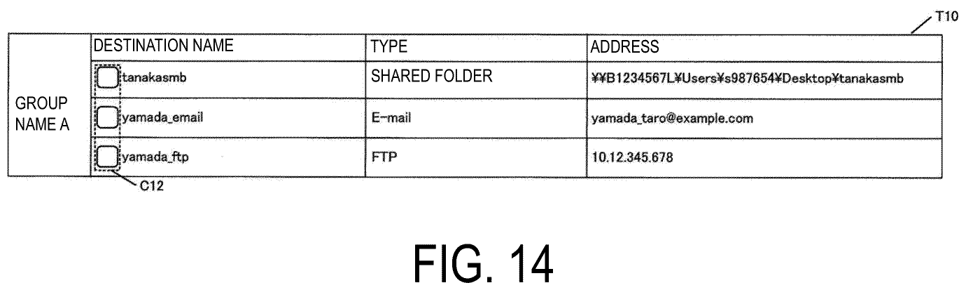

The apply-to-destinations-in-group button B34 is a button for receiving an instruction to select, in addition to “aaa@example.com”, a group destination in which a plurality of destinations are collected as one destination as the destination to which the encryption setting is to be applied in the batch manner. Here, a specific example of the group destination will be described below with reference to FIG. 14.

FIG. 14 is a table showing an example of the plurality of destinations other than “aaa@example.com” belonging to a group destination A (group A), which is an example of a group. Note that, although FIG. 14 shows an example in which the plurality of destinations belonging to the group are managed in a table T10, the plurality of destinations may be managed in a database format.

Table T10 includes a destination name, a type, an address, and a destination selection check box C12 as management items.

The destination name indicates a destination name of each of the plurality of destinations belonging to the group destination A. FIG. 14 illustrates a state in which destinations represented by three destination names “tanakasmb”, “yamada_email”, and “yamada_ftp” belong to the group destination A as the plurality of destinations belonging to the group destination A.

The type indicates a kind (type) of a communication protocol adopted by each of the destinations or a function compliant with the protocol. The address indicates an address of the destination based on the type. For example, the type of the destination represented by the destination name “tanakasmb” is a shared folder (file sharing) compliant with the communication protocol SMB, and the address thereof is ¥¥B1234567L¥Users¥s987654¥Desktop tanakasmb.

The destination selection check box C12 is a check box for receiving a selection of a destination excluded from the application of the encryption setting. The user can exclude the destination from the batch application of the encryption setting by checking the destination selection check box C12 corresponding to each of the destination names. FIG. 14 illustrates a state in which all of the destinations related to the three destination names are the destinations to which the encryption setting is to be applied.

The table T10 illustrated in FIG. 14 may be displayed on the display 13 when the apply-to-destinations-in-group button B34 is selected by the user on the input screen B34, or may receive the selection of the destination excluded from the batch application of the encryption setting at the time of the system setting (device setting). Note that in a case in which the setting is already completed in the system setting, upon receiving the instruction to select the button B34 on the input screen W41, the application confirmation screen W72 may be displayed without displaying the table T10.

FIG. 15 is a diagram illustrating a configuration example of the application confirmation screen W72 displayed on the display 13 when the apply-to-destinations-in-group button B34 is selected on the input screen W41, or after the selection of the applicable destination excluded from the application is completed in the table T10 illustrated in FIG. 14.

Since the configuration of the application confirmation screen W72 illustrated in FIG. 15 can be the same as that of the application confirmation screen W70 illustrated in FIG. 12 except for a notification “Do you want to apply the following setting to the other destinations of the group destination A?” indicating that the encryption setting will be applied in the batch manner to the destinations belonging to the group destination A, description thereof is omitted here.

Note that FIG. 15 also illustrates a state in which the password display restriction icon 110 is selected by the user and the encryption password input to the password input box Bx12 is visible.

FIG. 16 is a configuration example of the input screen W43 displayed by the controller 11 when a plurality of specific destinations are selected as the destinations to which the encryption setting is to be applied in the batch manner, and is an operation example corresponding to the processing at step S340 in FIG. 4. The input screen W43 includes a batch-application-to-specific-destinations button B36 instead of the batch application button B22 of the input screen W35 illustrated in FIG. 9. Since the configuration of the input screen W43 other than the batch-application-to-specific-destinations button B36 can be the same as that of the input screen W35, description thereof is omitted here.

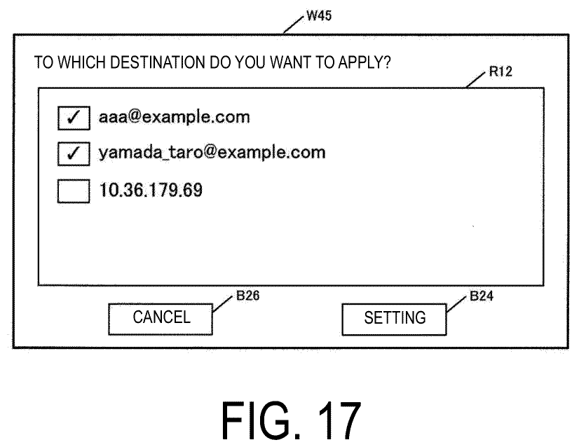

The batch-application-to-specific-destinations button B36 is a button for receiving an instruction to select a plurality of specific destinations including “aaa@example.com” as the destinations to which the encryption setting is to be applied in the batch manner. Upon receiving an instruction to select the batch-application-to-specific-destinations button B36, the controller 11 displays a destination selection screen W45, which will be described below with reference to FIG. 17.

The destination selection screen W45 includes a selection area R12 for receiving an instruction to select destinations as the applicable destinations to which the encryption setting is to be applied in the batch manner, the set button B24, and the cancel button B26. The user selects desired destinations via the selection area R12, and then selects the set button B24 to encrypt the transmission data for the selected destinations in the batch manner. Note that FIG. 17 illustrates an example in which two addresses “aaa@example.com” and “yamada_taro@example.com” are selected as the plurality of specific destinations. The cancel button B26 is a button for receiving an instruction to cancel the selection of the destinations by the user via the destination selection screen W45. Upon receiving an instruction to select the cancel button B26, the controller 11 ends the display of the destination selection screen W45 and displays the previous screen (in this case, the input screen W43).

FIG. 18 is a diagram illustrating a configuration of the input screen W47 displayed on the display 13 when the set button B24 of the destination selection screen W45 is selected.

Since the configuration of the input screen W47 illustrated in FIG. 18 can be the same as that of the input screen illustrated in FIG. 16 or the like except for a notification “Please set encryption setting to be applied to a plurality of destinations.” prompting the user to input a PDF encryption setting to be applied to a plurality of destinations, description thereof is omitted here. Note that, after the encryption setting has been performed on the input screen W43, when the input screen W47 is displayed by the user selecting the batch-apply-to-specific-destinations button B36, the input screen W47 may be displayed while reflecting the encryption setting performed on the input screen W43.

FIG. 19 is a configuration example of the input screen W49 displayed by the controller 11 when destinations related to a specific job type are selected as the applicable destinations to which the encryption setting is to be applied in the batch manner, and is an operation example corresponding to the processing at step S350 in FIG. 4. The input screen W49 includes a batch-application-to-specific-job button B38 instead of the batch application button B22 of the input screen W35 illustrated in FIG. 9. Since the configuration of the input screen W49 can be the same as that of the input screen W35 expect for the batch-application-to-specific-job button B38, description thereof is omitted here.

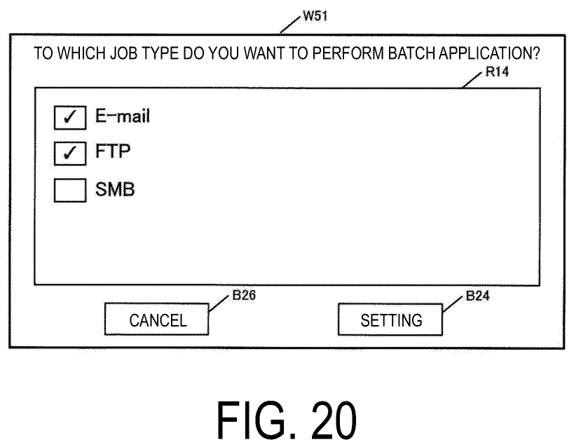

The batch-application-to-specific-job button B38 is a button for receiving an instruction to select a specific job type as destinations to which the encryption setting is to be applied in the batch manner. Upon receiving an instruction to select the batch-application-to-specific-job button B38, the controller 11 displays a specific job type selection screen W51, which will be described below with reference to FIG. 20.

The specific job type selection screen W51 includes a selection area R14 for receiving an instruction to select a specific job type as the applicable destinations to which the encryption setting is to be applied in the batch manner, the set button B24, and the cancel button B26. The user selects a desired job type via the selection area R14, and then selects the set button B24 to encrypt the transmission data for the destinations related to the selected job type in the batch manner. Note that FIG. 20 illustrates an example in which two job types “E-mail” and “FTP” are selected by the user as the specific job types. The cancel button B26 is a button for receiving an instruction to cancel the selection of the job type via the specific job type selection screen W51. Upon receiving an instruction to select the cancel button B26, the controller 11 ends the display of the specific job type selection screen W51 and displays the previous screen (in this case, the input screen W49).

FIG. 21 illustrates a configuration example of the input screen W53 displayed by the controller 11 when the one-time password is generated at the time of the encryption setting such as when the individual application button B12 is selected by the user on the selection screen W53 illustrated in FIG. 7. The input screen W53 includes a password generation button B40 instead of the batch application button B22 of the input screen W35 illustrated in FIG. 9. Since the configuration of the input screen W53 can be the same as that of the input screen W35 expect for the password generation button B40, description thereof is omitted here.

The password generation button B40 is a button for receiving a user's input of an instruction to automatically generate the one-time password related to the encryption setting. Upon receiving an instruction to select the password generation button B40, the controller 11 displays a password generation screen W74, which will be described below with reference to FIG. 22.

Since the configuration of the password generation screen W74 can be the same as those of the application confirmation screens W70 and W72 illustrated in FIGS. 12 and 15 and the like except for a notification “Password has been generated. Do you want to apply the password?” inquiring the user whether or not to apply the generated password to the encryption setting and a regeneration button B42, description thereof is omitted here.

The regeneration button B42 is a button for receiving an instruction to regenerate the one-time password. Upon receiving an instruction to input the regeneration button B42, the controller 11 generates a new one-time password.

Upon receiving an instruction to select the YES button B30, the controller 11 applies the encryption setting to the transmission data, executes transmission of the encrypted transmission data, and when the transmission of the encrypted transmission data is completed, transmits the set one-time password to the notification destination input in the password notification destination input box Bx10 on the encryption setting screen W14. Note that the generated one-time password may be displayed on the display 13 as a QR code (registered trademark), for example, and the QR code (registered trademark) may be read by a terminal device or the like.

As described above, according to the first embodiment, with respect to the encryption setting such as the selection of the encryption level and the setting of the encryption password for the transmission data, it is possible to encrypt the transmission data based on the application setting of either the batch application in which the encryption setting is applied in the batch manner to the transmission data for the plurality of destinations, or the individual application in which the encryption setting is individually applied to the transmission data for each of the plurality of destinations. Further, in the first embodiment, since the application setting of either the batch application or the individual application can be selected for each job (user setting), the user can easily set a desired encryption setting.

Further, according to the first embodiment, even after the individual application is selected, the encryption setting can be applied in the batch manner to at least some of the other destinations among the plurality of destinations, in addition to the destination to which the individual application is to be applied. Thus, even for the user who wants to individually apply the encryption setting to each of the plurality of destinations, it is possible to secure convenience at the time of the encryption setting of the transmission data.

### 2 Second Embodiment

In a second embodiment, when individually applying the encryption setting, the applicable destinations to which the encryption setting is to be applied in the batch manner are set by combining the destinations having the shared domain, the group destination in which the plurality of destinations are collected as one destination, the plurality of specific destinations, and the destinations related to the specific job type. Note that the combination can be set in advance by the system setting, or can be set on an operation screen for each job.

In the second embodiment, for example, the applicable destinations to which the encryption setting is to be applied in the batch manner can be set by combining the destinations having the shared domain and the destinations related to the specific job type.

Note that the combination of the applicable destinations is not limited to the destinations having the shared domain and the destinations related to the specific job type, and may be a combination of the group destination and the plurality of specific destinations. The combination of the applicable destinations to which the encryption setting is to be applied in the batch manner can be appropriately set or changed by the user.

As described above, according to the second embodiment, in addition to the effect of the first embodiment, the applicable destinations to which the encryption setting is to be applied in the batch manner can be set by combining the destinations having the shared domain, the group destination in which the plurality of destinations are collected as one destination, the plurality of specific destinations, or the destinations related to the specific job type. Thus, it is possible to increase a degree of freedom in selecting the applicable destinations related to the encryption setting.

The disclosure is not limited to the above-described embodiments, and various modifications are possible. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination within a technically possible scope.

Further, in the embodiment, a program operating on each device is a program that controls a CPU or the like (a program for causing a computer to function) to realize the functions of the above-described embodiment. Information handled by such a device is temporarily stored in a temporary storage device (for example, a RAM) during processing and then stored in various storage devices such as read only memories (ROMs) and HDDs, and is read, modified, and written by the CPU as necessary.

Here, a computer-readable non-transitory recording medium on which the program is recorded in the information processing apparatus may be any of a semiconductor medium (for example, a ROM or a non-volatile memory card), an optical recording media/magnetic optical recording medium (for example, a digital versatile disc (DVD), magneto optical disc (MO), mini disc (MD), compact disc (CD), Blu-ray (BD; registered trademark) disc), or the like), a magnetic recording medium (for example, a magnetic tape or flexible disk), and the like. In this case, the program recorded on the recording medium is read by the computer of the information processing apparatus and executed by the computer, so that not only the functions of the above-described embodiment are realized, but also functions of the present disclosure are realized by performing processing in cooperation with an operating system, another application program, or the like based on instructions of the program.

Further, when a program is distributed in the market, the program can be stored in a portable recording medium and distributed, or can be transferred to a server computer connected via a network such as the Internet. In this case, it is obvious that a storage device of the server computer is also included in the present disclosure.

Further, each functional block or feature of the device used in the above-described embodiment can be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing apparatus comprising:
a transmitter that transmits transmission data to a designated destination; and
one or more controllers that control encryption of the transmission data based on an encryption setting set by a user,
wherein the one or more controllers encrypt the transmission data based on an application setting of either a batch application in which the encryption setting is applied in a batch manner to the transmission data for a plurality of the destinations, or an individual application in which the encryption setting is individually applied to the transmission data for the plurality of destinations, and
the transmitter transmits the transmission data to the plurality of destinations.

2. The image processing apparatus according to claim 1,
wherein the one or more controllers receive, as a device setting, the application setting of any one of the batch application, the individual application, and a user setting in which the batch application or the individual application is selectable.

3. The image processing apparatus according to claim 2,
wherein the one or more controllers receive, as the device setting, the application setting of any one of the batch application, the individual application, and the user setting for each user.

4. The image processing apparatus according to claim 2 comprising
a display,
wherein, when the user setting is selected as the device setting, the one or more controllers display, on the display, a selection screen that receives a selection of the application setting of either the batch application or the individual application.

5. The image processing apparatus according to claim 4,
wherein the one or more controllers display, on the display, an input screen that receives an input of at least an encryption level and an encryption password as the encryption setting, in accordance with a selection result received via the selection screen.

6. The image processing apparatus according to claim 5,
wherein, when the individual application is selected as the application setting, the one or more controllers apply in the batch manner the encryption setting received via the input screen to the transmission data for at least some destinations of the plurality of destinations.

7. The image processing apparatus according to claim 6,
wherein the at least some destinations of the plurality of destinations includes at least one of a destination having a shared domain, a group destination in which a plurality of the destinations are collected as one destination, a plurality of specific destinations, and a destination related to a specific job type.

8. An encryption setting method comprising:
controlling encryption of transmission data based on an encryption setting set by a user;
encrypting the transmission data based on an application setting of either a batch application in which the encryption setting is applied in a batch manner to the transmission data for a plurality of the destinations, or an individual application in which the encryption setting is individually applied to the transmission data for the plurality of destinations; and
transmitting the encrypted transmission data to the plurality of destinations.
